(19) United States
(12) Patent Application Publication
(10) Pub. No.: US 2022/0137965 A1
(43) Pub. Date: May 5, 2022

(54) AUTOMATION METHOD, AUTOMATION SYSTEM AND AUTOMATION PROGRAM

(71) Applicants: Katsuhiko FUKUKI, Tokyo (JP); Tomoya FUKUKI, Tokyo (JP)

(72) Inventors: Katsuhiko FUKUKI, Tokyo (JP); Tomoya FUKUKI, Tokyo (JP)

(21) Appl. No.: 17/431,706

(22) PCT Filed: Feb. 14, 2020
(86) PCT No.: PCT/JP2020/005827

§ 371 Date: Aug. 17, 2021

(30) Foreign Application Priority Data
Feb. 21, 2019 (JP) 2019-029642

(51) Int. Cl. G06F 9/30; G06F 9/451; G06F 40/18; G06F 8/38

(52) U.S. Cl. CPC G06F 9/3017; G06F 8/38; G06F 40/18; G06F 9/451

(57) ABSTRACT

The problem to be solved by the present invention is to implement an automation method which enhances user experience in software operation. In a computer processor, executed are: a building step for registering a macro that includes one or more information processing procedures and an execution order related to the one or more information processing procedures; and an execution step for performing a sequential execution for sequentially executing the one or more information processing procedures based on the execution order in response to specifying the macro, and an individual execution for individually executing at least one of the one or more information processing procedures in response to specifying the at least one of the one or more information processing procedures.

This is National Stage Application of International Patent Application No. PCT/JP2020/005827 which claims priority to Japanese Patent Application No. 2019-029642 filed on Feb. 21, 2019. The entire content of Japanese Patent Application No. 2019-029642 is incorporated herein by reference.

### TECHNICAL FIELD

The present invention relates to an automation method, an automation system and an automation program.

### BACKGROUND ART

The recording of a macro is known as an automation method in conventional spreadsheet software, which does not depend on character user interfaces. Although the recording of a macro is capable of providing an intuitive user experience, it is difficult for the recording of a macro to set branch processing and iterative processing among the three elements of programming, a sequential execution, the branch processing and the iterative processing (see Non-Patent Document 1).

The invention described in Patent Document 1 discloses a work automation support system that includes a PC and a management server. The PC has a browser operation storage agent configured to store, on a file server, a browser process definition file and an operation screen, and an operation storage agent configured to store, on the file server, a spreadsheet process definition file for a spreadsheet software operation and a spreadsheet file. The management server is configured to generate a pop-up screen for registering a logical formula for each process step in a process flowchart generated based on the browser process definition file and the like to generate an input file for a work automation tool. The logical formula specifies the same target tag or cell when the operation always targets the same tag or cell, and the logical formula specifies a different target tag or cell based on an operation target condition when the operation targets a tag or cell depending on the condition.

### PRIOR ART DOCUMENT

### Patent Document

Patent Document 1: JP6063235

### Non-Patent Document

Non-Patent Document 1: Atsushi Omura, Real Introduction to Excel (registered trademark) VBA—From Automation of Daily Routines to Application Development—, Gijutsu-Hyohron Co., Ltd., published on Jun. 20, 2015, P. 56

### SUMMARY OF THE INVENTION

### Problem to be Solved by the Invention

However, in the invention described in Patent Document 1, users are not capable of recording all of the operations through user intuitive operations, such as a graphical user interface. For example, pop-up screens are capable of handling only at least a part of users' operations that are to be automated. In order to avoid, as much as possible, entry of characters using character user interfaces, such as in programing, which users are hesitant to try, there is a need to provide an environment where automatization is achieved using graphical user interfaces.

The present invention was made in view of the above situation, and the present invention defines, as a problem to be solved, the realization of an automation method, which improves the user experience in software operations in a simpler manner.

### Solution to Problems

In order to solve the above problems, the present invention is an automation method, which causes a computer processor to execute a building step for registering a macro, which includes one or more information processing procedures and an execution order related to the one or more information processing procedures. According to the present invention, one or more segmented software operations are defined as a macro.

A preferred embodiment of the present invention is an automation method, which causes the computer processor to further execute an execution step for performing a sequential execution for sequentially executing the one or more information processing procedures based on the execution order in response to specifying the macro, and an individual execution for individually executing at least one of the one or more information processing procedures in response to specifying the at least one of the one or more information processing procedures. The present invention is capable of individually executing one or more segmented software operations included in a macro.

In a preferred embodiment of the present invention, the building step is based on a graphical user interface. According to the present invention, intentions of performing the sequential execution and the individual execution of one or more segmented software operations are respectively inputted based on an intuitive user interface.

In a preferred embodiment of the present invention, the building step associates the one or more information processing procedures with branch processing and/or iterative processing. According to the present invention, branch processing and iterative processing, which are conventionally not achievable by the recording of a macro based on only a graphical user interface, are realized using another graphical user interface.

In a preferred embodiment of the present invention, the information processing procedure is a spreadsheet processing procedure. The present invention is capable of introducing a simpler automation method for a spreadsheet software, which has been eagerly automatized using the recording of a macro conventionally. Furthermore, in a preferred embodiment of the present invention, the macro belongs to a spreadsheet. In addition, in a preferred embodiment of the present invention, the building step stores the macro on a main storage device, which serves as a volatile cache area. Still further, in a preferred embodiment of the present invention, the building step stores the macro on an auxiliary storage device, which serves as a non-volatile data area. Also, in a preferred embodiment of the present invention, the execution step stores the macro on a main storage device, which serves as a volatile cache area. Furthermore, in a preferred embodiment of the present invention, the execution step stores the macro on an auxiliary storage device, which serves as a non-volatile data area.

In order to solve the above problems, the present invention is an automation system, which includes building means for registering a macro, which includes one or more information processing procedures and an execution order related to the one or more information processing procedures.

In order to solve the above problems, the present invention is an automation program, which causes a computer to function as building means for registering a macro, which includes one or more information processing procedures and an execution order related to the one or more information processing procedures.

### Advantageous Effects of Invention

The present invention is capable of providing an automation method that improves the user experience in software operations in a simpler manner.

### BRIEF DESCRIPTION OF DRAWINGS

FIG. 1 shows a hardware configuration diagram according to the first embodiment.

FIG. 2 is a function block diagram according to the first embodiment.

FIG. 3A is a processing flowchart according to the first embodiment.

FIG. 3B is a processing flowchart according to the first embodiment.

FIG. 3C is a processing flowchart according to the first embodiment.

FIG. 4 is a schematic diagram of a macro according to the first embodiment.

FIG. 5 is an example of a building screen when a format tab is specified in a process specifying unit according to the first embodiment.

FIG. 6 is an example of the building screen when there is a specified condition in a condition specifying unit according to the first embodiment.

FIG. 7 is an example of a building screen when a copy & cut tab is specified in the process specifying unit according to the first embodiment.

FIG. 8 is an example of the building screen when an input tab is specified in the process specifying unit according to the first embodiment.

FIG. 9 is an example of the building screen when a data tab is specified in the process specifying unit according to the first embodiment.

FIG. 10 is an example of the building screen when a Misc. tab is specified in the process specifying unit according to the first embodiment.

FIG. 11A is examples of each of a sequential execution screen and an individual execution screen according to the first embodiment.

FIG. 11B is examples of each of a sequential execution screen and an individual execution screen according to the first embodiment.

FIG. 12 is a hardware configuration diagram according to the second embodiment.

FIG. 13A is a function block diagram according to the second embodiment.

FIG. 13B is a function block diagram according to the second embodiment.

FIG. 14A is a function block diagram according to the third embodiment.

FIG. 14B is a function block diagram according to the second embodiment.

FIG. 15A is a function block diagram according to the fourth embodiment.

FIG. 15B is a function block diagram according to the second embodiment.

FIG. 16A is a function block diagram according to the fifth embodiment.

FIG. 16B is a function block diagram according to the second embodiment.

FIG. 17A is a function block diagram according to the sixth embodiment.

FIG. 17B is a function block diagram according to the second embodiment.

FIG. 18A is a function block diagram according to the seventh embodiment.

FIG. 18B is a function block diagram according to the second embodiment.

FIG. 19A is a function block diagram according to the eighth embodiment.

FIG. 19B is a function block diagram according to the second embodiment.

### MODES FOR CARRYING OUT THE INVENTION

### First Embodiment

hereinafter, the first embodiment of a system according to the present invention will be described with reference to the drawings. The present embodiment describes configurations, operations, and the like of a system, but methods, a server 1B, a program P0, a storage medium, and etc., which have configurations similar to the above, also have the same advantages. Further, the program P0 may be stored in a storage medium. The usage of the storage medium enables installation of the program P0 in a computer device 1, for example. Note that the storage medium that stores the program P0 is, for example, a non-transient storage medium, such as a CD-ROM or a flash memory. Further, it is obvious that the storage medium is necessary as a provider and container of the program P0 even when the program P0 is distributed through an electric line. In addition, the program P0 includes a source code or a binary and is encrypted as appropriate.

Hereinafter, the system according to the embodiment of the present invention will be described with reference to the drawings. Note that embodiments shown below are examples of the present invention, and the present invention is not limited to the following embodiments, and various configurations may be adopted. In addition, there are no restrictions on the fields of businesses or services, to which the system according to the embodiments of the present invention is applied, provided that the effects and advantages of the system are obtained in the applied fields.

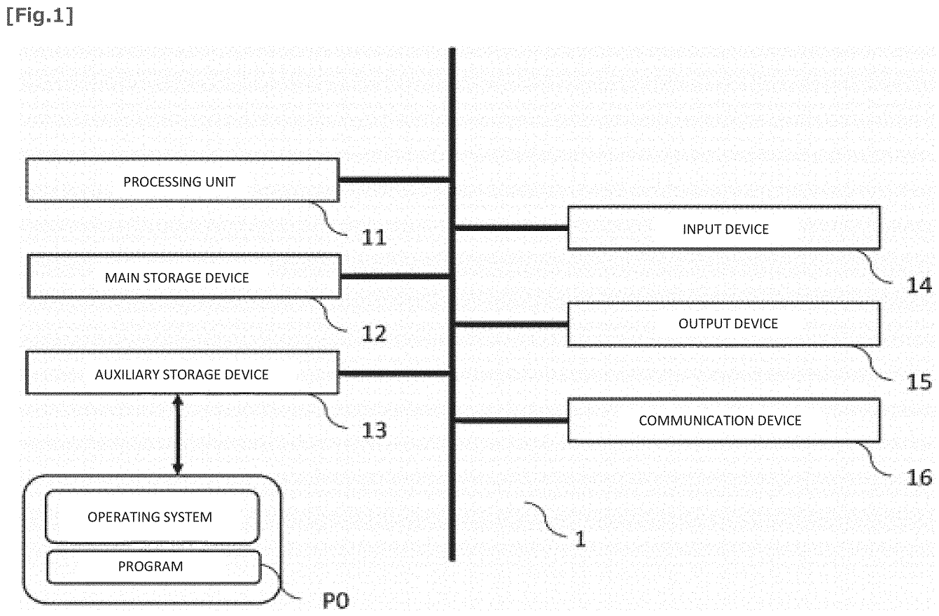

As shown in FIG. 1, the system includes a computer device 1. The computer device 1 includes a processing unit 11, a main storage device 12, an auxiliary storage device 13, an input device 14, an output device 15, a communication device 16, and a bus interface for connecting therebetween. The computer device 1 may be connected with a network NW. Hardware resources of the system are used in order to, at least, realize functions of the program P0.

The processing unit 11 includes a processor core, such as a central processing unit (CPU).

The main storage device 12 has a volatile device, one example of which is a random access memory (RAM). The auxiliary storage device 13 includes a non-volatile device, such as a hard disk drive (HDD) and a solid state drive (SSD). The auxiliary storage device 13 stores each of data items related to the operating system (OS) and the program P0. The auxiliary storage device 13 may include a primary storage and one or more secondary storages. The auxiliary storage device 13 includes database.

The computer device 1 may include a system-on-chip (SoC), with which the processor core and an application specific integrated circuit (ASIC) are integrated. A processor including the processor core may be a programmable device. The ASIC refers to, for example, a digital signal processor (DSP), such as a hardware encoder/decoder, or a processor dedicated to machine learning (ML). The computer device 1 may include a memory device having a volatile cache area and a non-volatile data area.

The input device 14 is used for input processing of data related to the system. The input device 14 includes at least one of a keyboard, a touch panel, a microphone and an image sensor. In the above, there are no restrictions on methods of the above input processing.

The output device 15 is used for display processing of the system. The output device 15 includes a visual display device and a graphic controller. The examples of visual display device include a display device (e.g., a liquid crystal display (LCD)) and a projection device. The examples of the graphic controller include a graphics processing unit (GPU). The graphic controller may be included in the SoC. The output device 15 may be a device, such as a head mount display, which contacts at least part of a human body.

The communication device 16 is used for communication processing including data transmission/reception via the network NW. The communication device 16 supports wireless communication based on Wi-Fi (registered trademark) and/or wired communication based on Ethernet (registered trademark). The communication device 16 includes a transceiver for telecommunications using radio waves or light waves, and the wavelength band thereof is not limited. The communication protocol of the network NW in the system includes TCP/IP (Transmission Control Protocol/Internet Protocol).

The network NW may use a wired network and a wireless network. Examples of the wired network include optical lines and community antenna television (CATV) lines. Examples of the wireless network include mobile communication networks, aerial communication networks, and satellite communication networks. The network NW may include a packet switch depending on the networks.

The computer device 1 takes a form of a data terminal equipment, such as a laptop computer, a workstation, a smartphone and a wearable device. Each of one or more computer devices 1 may be configured to cooperate with each other so that the program P0 is installed on any of the one or more computer devices 1.

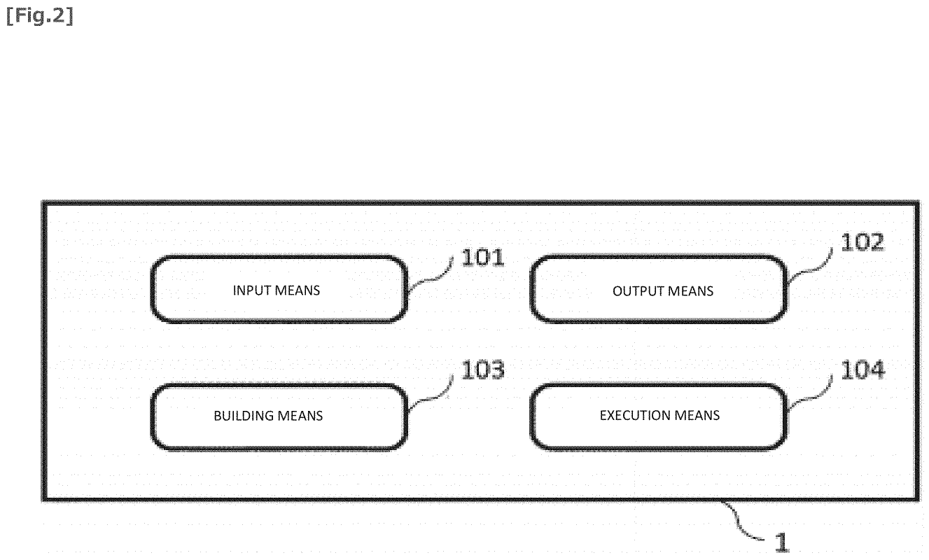

As shown in FIG. 2, the system has input means 101, output means 102, building means 103 and execution means 104. Functions related to the system are realized in cooperation with functions of a spreadsheet.

The input means 101 is used for inputting data related to the system. The input means 101 performs the input processing of the data via the input device 14. The data includes one or more information processing procedures and an execution command of the one or more information processing procedures according to the embodiment of the present invention. In addition to the above, the input means 101 may perform the input processing of the data via an application programming interface. The input processing of the data by the input means 101 is preferably realized in cooperation with display processing on a screen by the output means 102.

The output means 102 uses the output device 15 to perform the display processing of the data related to the system. The display processing includes providing (or displaying on the screen) a user interface used for the input processing of the data. The output means 102 may additionally perform the display processing via the application programming interface. The output means 102 is used for the display processing of a building screen W1, a sequential execution screen W2 and an individual execution screen W3. At least a part of each of the building screen W1, the sequential execution screen W2 and the individual execution screen W3 may be superimposed on the screen related to the spreadsheet. At least a part of each of the building screen W1, the sequential execution screen W2 and the individual execution screen W3 receives input via an input form having pull-down menus. The output means 102 may appropriately set drawing conditions displayed on the screen, including color designation, in order to facilitate the input processing of data. The specification of the drawing conditions is appropriately stored in a setting file.

The building means 103 registers a macro. The macro includes one or more information processing procedures and includes an execution order related to the one or more information processing procedures. The information processing procedure refers to, for example, spreadsheet processing including an operation process for a spreadsheet software. The building means 103 associates one or more information processing procedures with branch processing and/or iterative processing using a graphical user interface. The graphical user interface is realized through the screen display by the output means 102. In the building screen W1, the building means 103 makes a decision related to the information processing procedure based on the information specified by the input means 101.

The execution means 104 sequentially executes one or more information processing procedures based on the execution order in response to specifying the macro. The execution means 104 individually executes at least one of the one or more information processing procedures in response to the specifying the at least one of the one or more information processing procedures. The execution means 104 performs the sequential execution or the individual execution using the graphical user interface. The graphical user interface is realized using the screen displayed by the output means 102. The execution means 104 executes the information processing procedure based on the information specified by the input means 101 in the sequential execution screen W2 or the individual execution screen W3. The execution means 104 may be configured to store a macro in the main storage device 12, which serves as a volatile cache area. Further, the execution means 104 may be configured to store a macro in the auxiliary storage device 13, which serves as a non-volatile data area. In addition, the execution means 104 may be configured to perform the output processing related to the macro in cooperation with the output means 102. The output processing includes outputting the macro itself and the execution result of the macro.

Each of the one or more information processing procedures processes information related to an object, a method, and a property. The object is a processing target and is, for example, a cell range. The method is a command to operate the object, and refers to, for example, clearing a value of the cell. The property refers to, for example, a value in the cell range.

Functions related to the system are realized on a spreadsheet, for example. The spreadsheet is configured based on multiple data layers in the hierarchy of books, sheets and cells. The spreadsheet includes each of the cells arranged in a grid, a sheet, a book, and an identifier. Examples of the spreadsheet include Excel (registered trademark). Information, which is related to macros or steps, and data on the spreadsheet are stored in the database and referred to on the database. In the above, the information related to the macros or the steps may be stored in and referred to on different database sets. The macro language for writing the program P0, which includes a macro belonging to the spreadsheet according to the present invention, is not limited to Visual Basic (registered trademark) for Applications (VBA), the macro language for Excel (registered trademark). Alternatively, the macro language may be any macro language other than VBA. The program P0 may be written in a programming language, such as C++ (registered trademark) and Python (registered trademark). There are no restrictions on the programming language for writing the program P0.

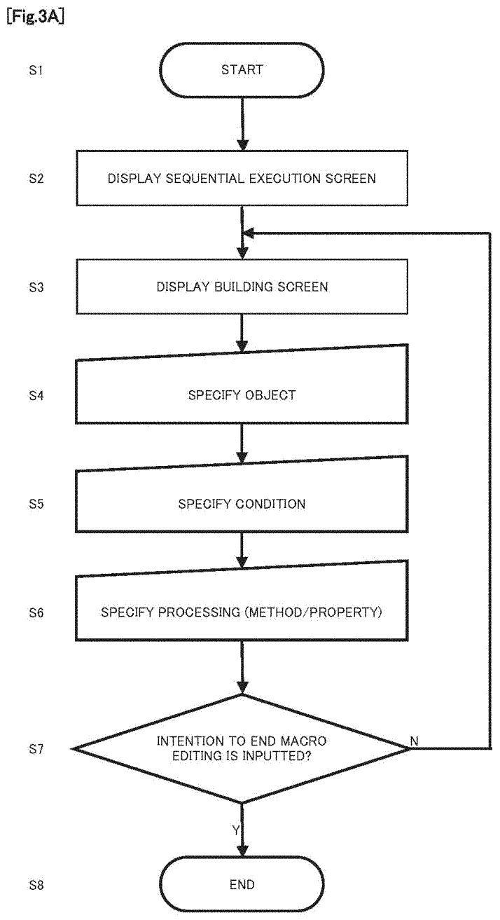

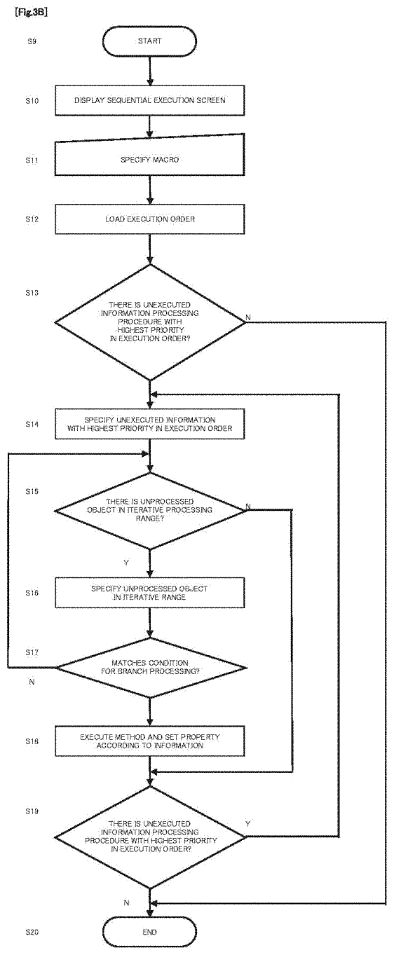

As shown in FIGS. 3A, 3B and 3C, the functions of the system are realized based on processing flowcharts including multiple steps. In step S1, an automation setup is started. In step S2, the output means 102 performs the display processing of the sequential execution screen W2. In step S3, the output means 102 performs the display processing of the building screen W1. In step S4, the building means 103 specifies the object. In step S5, the building means 103 specifies a condition. In step S6, the building means 103 specifies processing. When an intention to end macro editing is inputted (step S7, Y (Yes)), a control proceeds to step S8. When the intention to end macro editing is not inputted (step S7, N (No)), the control proceeds to step S3. In step S8, the automation setup ends. Note that the determination of an unprocessed state in FIGS. 3A, 3B and 3C, is made based on, for example, whether or not the existence of the object is judged.

As shown in FIG. 3B, in step S9, the process related to the sequential execution is started. In step S10, the output means 102 performs the display processing of the sequential execution screen W2. In step S11, the input means 101 specifies the macro. In step S12, the execution means 104 loads the execution order. When there is an unexecuted information processing procedure that has not been executed and has the highest priority in the execution order (step S13, Y (Yes)), the control proceeds to step S14. When there is no unexecuted information processing procedure with the highest priority in the execution order (step S13, N (No)), the control proceeds to step S20. In step S14, the execution means 104 specifies the unexecuted information processing procedure with the highest priority in the execution order. When there is an unprocessed object that has not been processed in an iterative processing range (step S15, Y (Yes)), the control proceeds to step S16. When there is no unprocessed object in the iterative processing range (step S15, N (No)), the control proceeds to step S19. In step S16, the execution means 104 specifies the unprocessed object in the iterative processing range. When the property of the unprocessed object in the iterative processing range matches a condition for branch processing included in the information processing procedure (step S17, Y (Yes)), the control proceeds to step S18. When the property of the unprocessed object in the iterative processing range does not match the condition for the branch processing included in the information processing procedure (step S17, N (No)), the control proceeds to step S15. In step S18, the execution means 104 executes a method and sets a property according to the information processing procedure. When there is an unexecuted information processing procedure with the highest priority in the execution order (step S19, Y (Yes)), the control proceeds to step S14. When there is no unexecuted information processing procedure with the highest priority in the execution order (step S19, N (No)), the control proceeds to step S20. In step S20, the process related to the sequential execution ends.

As shown in FIG. 3C, in step S21, a process related to the individual execution is started. In step S22, the output means 102 performs the display processing of the individual execution screen W3. In step S23, the input means 101 specifies a step (information processing procedure). When there is an unprocessed object in the iterative processing range (step S24, Y (Yes)), the control proceeds to step S25. When there is no unprocessed object in the iterative processing range (step S24, N (No)), the control proceeds to step S29. In step S25, the execution means 104 specifies the unprocessed object in the iterative processing range. When a property of the unprocessed object in the iterative processing range matches a condition for branch processing included in the information processing procedure (step S26, Y (Yes)), the control proceeds to step S27. When the property of the unprocessed object in the iterative processing range does not match the condition for the branch processing included in the information processing procedure (step S26, N (No)), the control proceeds to step S24. In step S27, the execution means 104 executes a method and sets a property according to the information processing procedure. When there is the unprocessed object in the iterative processing range (step S28, Y (Yes)), the control proceeds to step S25. When there is no unprocessed object in the iterative processing range (step S28, N (No)), the control proceeds to step S29. In step S29, the process related to the individual execution ends.

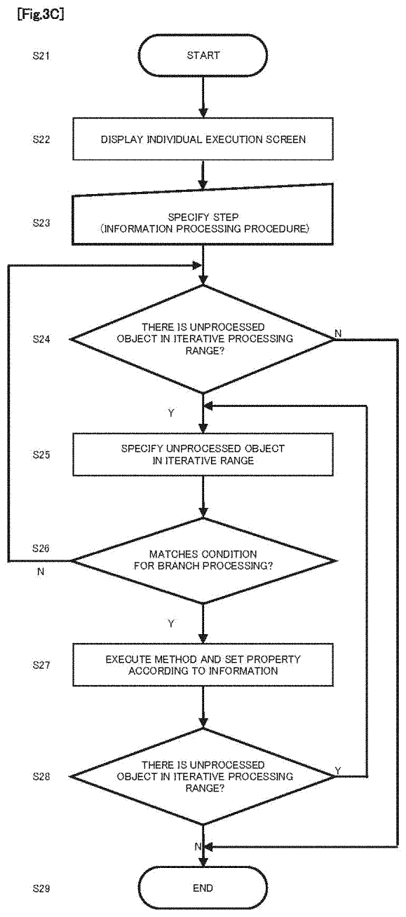

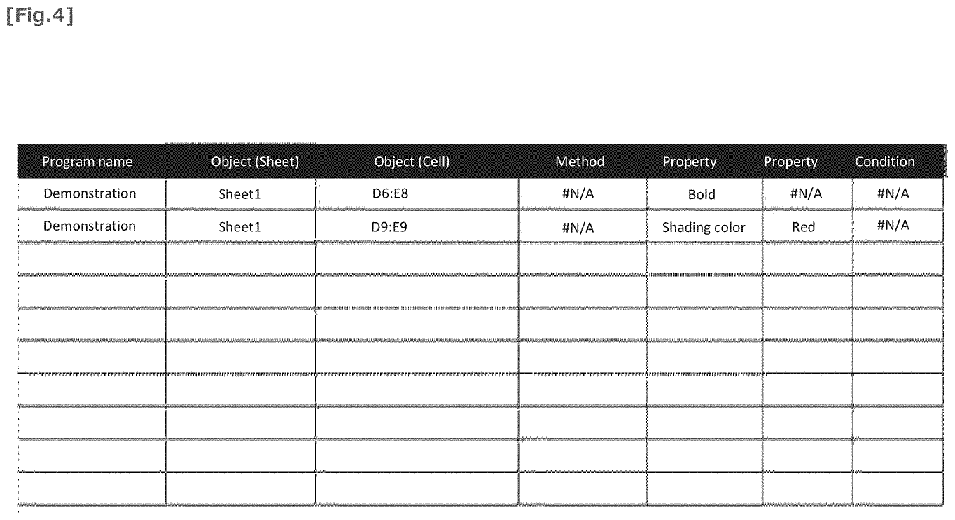

As shown in FIG. 4, each of one or more steps included in the macro relates to at least a macro identifier, a sheet identifier, an object, a method, a property and a condition. The macro includes information related to the execution order for the one or more steps. The macro identifier takes a form of a name of the program P0, for example. The sheet identifier takes a form of a sheet name, for example. The condition corresponds to condition values in FIG. 4. A step is synonymous with an information processing procedure.

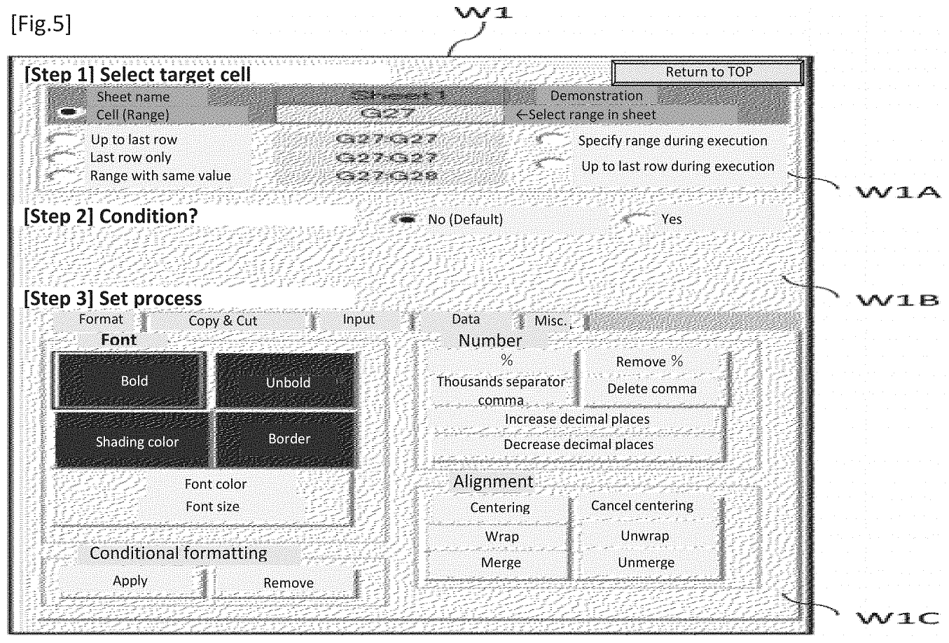

As shown in FIG. 5, the building screen W1 has an object specifying unit W1A, a condition specifying unit W1B and a process specifying unit W1C. The object specifying unit W1A is used to specify an object that relates to the macro or the step. The condition specifying unit W1B is used to specify a condition that relates to the macro or the step. The process specifying unit W1C is used to specify an information processing procedure that relates to the macro or the step. The process specifying unit W1C uses a tab interface. In response to specifying a tab by the process specifying unit W1C, the output means 102 performs the display processing of a screen mode according to the specified tab. The tab includes any of a format tab, a copy & cut tab, an input tab and a data tab. The process specifying unit W1C is used to specify a method and a property used in the information processing procedure.

As shown in FIG. 5, in the object specifying unit W1A, the input means 101 specifies, as the object targeted in the macro or the step, a cell range or an expanded cell range that includes the cell range. In the above, the expanded cell range may include a group of cells, which is non-contiguous with the cell range in a row direction and/or a column direction. In the object specifying unit W1A, the input means 101 may specify a part of the expanded cell range as the object. Specifically, in the object specifying unit W1A, the input means 101 may specify, as the object, a cell range in the last row or last column of the expanded cell range. In the object specifying unit W1A, the input means 101 may specify, as the object, one or more cells in the expanded cell range having a specific value. The object specifying unit W1A has a macro editing end intention input unit for inputting, by the input means 101, the intention to end the editing of the macro.

As shown in FIG. 5, in the process specifying unit W1C, in which the format tab is specified, the input means 101 may specify a font, a numerical value, and a text alignment. The setting related to the font includes at least one of a bold, a shading, a border, a color, and a size. The setting related to the numerical value includes at least one of changing of percentage format, changing of comma format, and changing of decimal places. The settings related to the text alignment include at least one of an alignment type, a wrapping, and a cell merging.

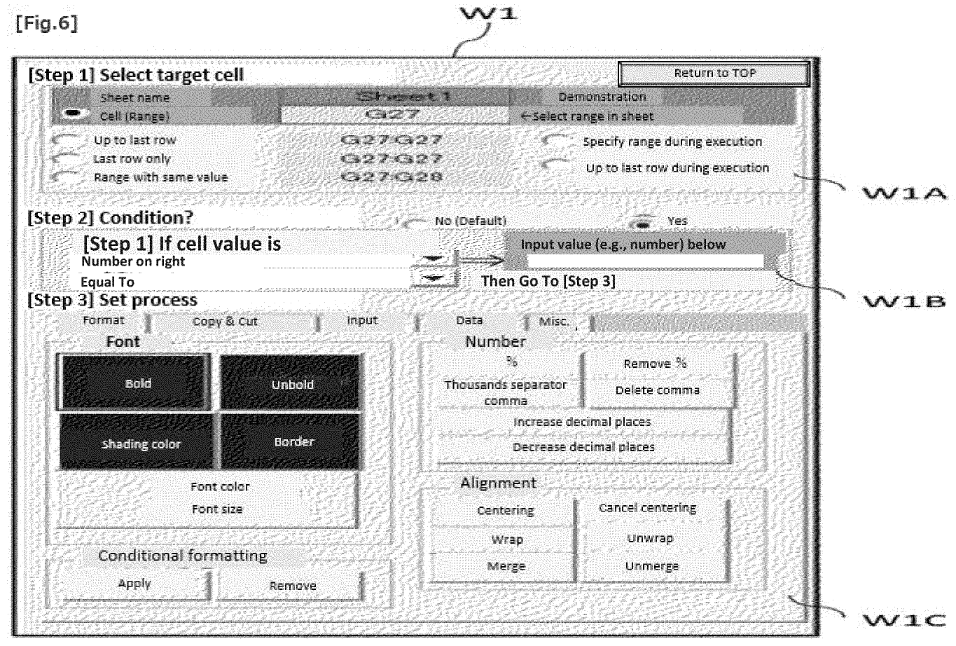

As shown in FIG. 6, when the condition specifying unit W1B specifies that there is a condition, the output means 102 switches the screen mode of the condition specifying unit W1B. The input means 101 may specify information constituting the condition that relates to the macro or the step. As an example, the condition includes a result of a logical operation based on a target cell, which satisfies the condition, and a cell adjacent to the targeted cell. The above logical operation may be based on a value of a cell that is not adjacent to the targeted cell. The building means 103 may preferably specify a step to proceed next based on a Boolean value of the condition.

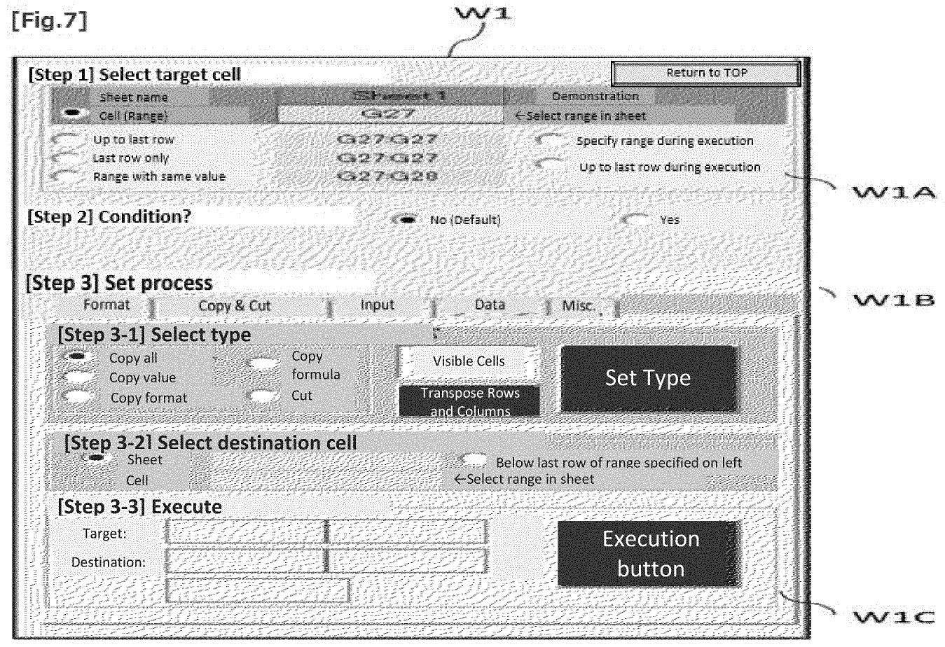

As shown in FIG. 7, in the process specifying unit W1C, in which the copy & cut tab is specified, the input means 101 may specify a cell operation based on a value of the cell that relates to the macro or the step. The cell operation is preferably to copy and paste the value. In the process specifying unit W1C, the input means 101 specifies a destination cell for pasting, which is other than the targeted cell.

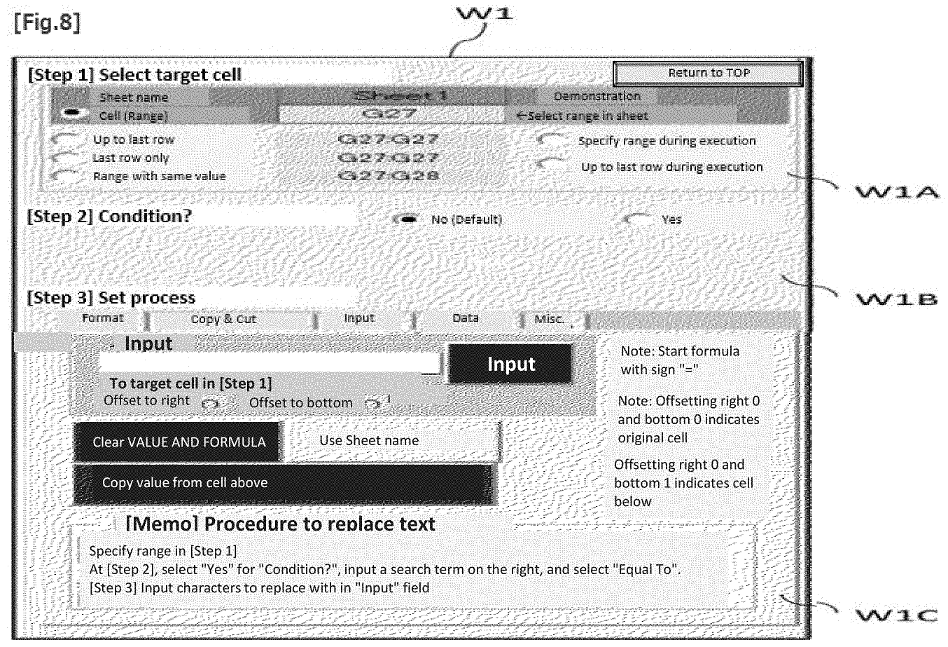

As shown in FIG. 8, in the process specifying unit W1C, in which the input tab is specified, the input means 101 may specify the value to be input into the cell targeted by the macro or the step. The input value is a number or a character string. The process specifying unit W1C includes at least one of an input form for inputting the input value, an input value confirmation intention input unit for confirming the input value displayed in the input form, an input value cancellation intention input unit for deleting the input value displayed in the input form, and an input value reference intention input unit for inputting, as the input value, a value contained in a cell adjacent to the cell serving as the object.

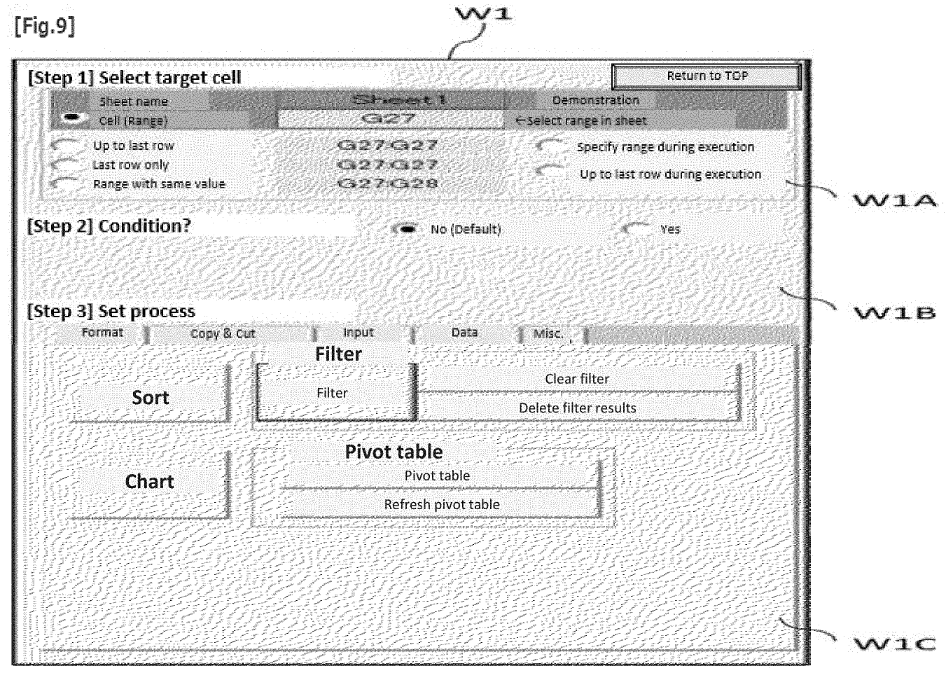

As shown in FIG. 9, in the process specifying unit W1C, in which the data tab is specified, the input means 101 may specify at least one of a sorting process, a filtering process, a chart creating process, a pivot table setting process based on the target cell range. The sorting process refers to sorting of the cell range. The filtering process refers to switching between hiding and unhiding cells based on an arbitrary logical formula. The arbitrary logical formula may be a condition specified in the condition specifying unit W1B, or alternatively a different condition separately accepted via the input processing. The process specifying unit W1C includes a filtering cancellation intention input unit for cancelling the filtering process, and a filtering result deletion intention input unit for suppressing the display processing of a filtering result or for deleting a cell resulting from the filtering process. The pivot table process includes setting of the pivot table based on the cell range.

As shown in FIG. 10, the process specifying unit W1C, in which the Misc. tab is specified, includes a sheet information change intention input unit for changing each of adding a sheet and changing a sheet identifier, or a row and column information change intention input unit for changing row and column information, such as switching between hiding and unhiding rows and columns and changing sizes of the row and the column.

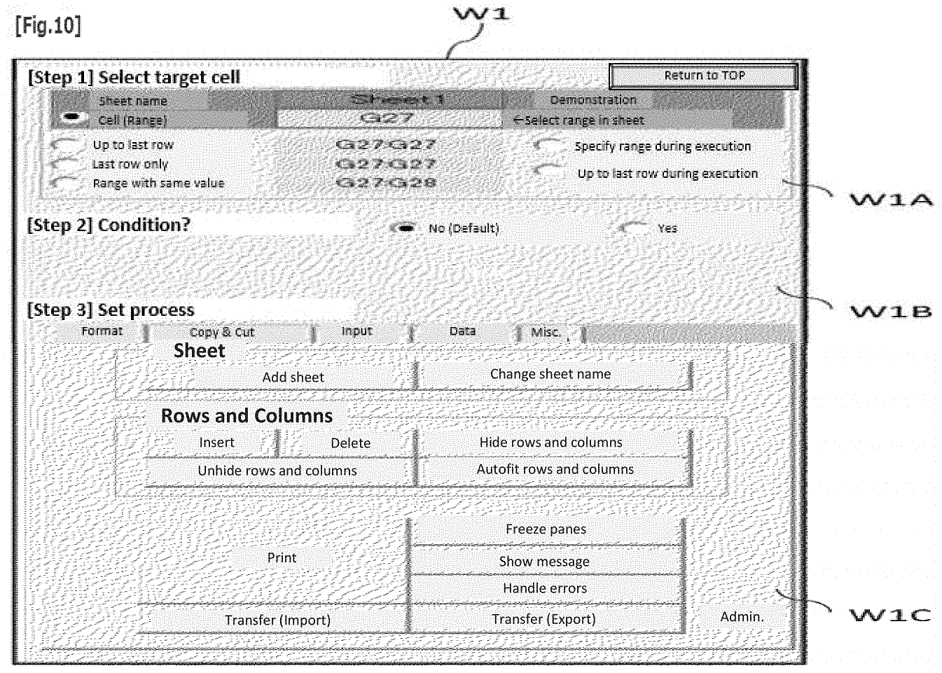

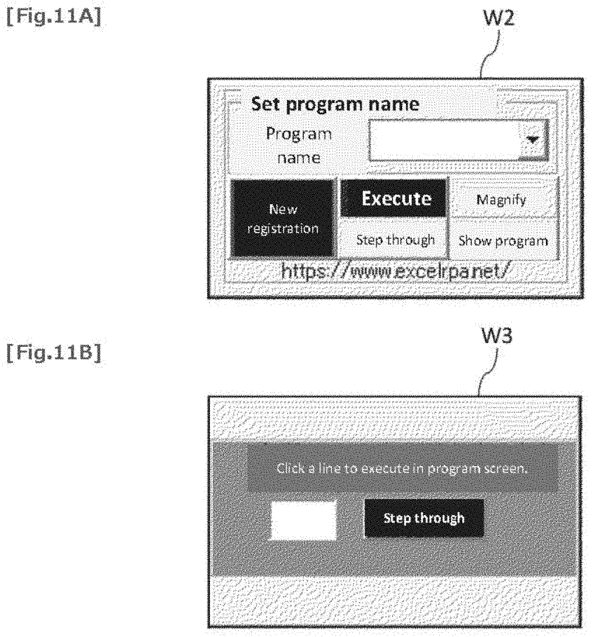

As shown in FIGS. 11A and 11B, the sequential execution screen W2 has a sequential execution intention input unit for inputting the intention of the sequential execution. The sequential execution screen W2 has a screen size change intention input unit for changing screen sizes of the sequential execution screen W2, the individual execution screen W3 and the building screen W1. The sequential execution screen W2 has an individual execution screen W3 display intention input unit for switching to the individual execution screen W3. The sequential execution screen W2 has a macro details display intention input unit for displaying, on a spreadsheet, each step included in a macro as shown in FIG. 4. When the macro details display intention input unit is specified, the output means 102 displays, on a spreadsheet screen, information related to each of the information processing procedures included in the macro as shown in FIG. 4. The sequential execution screen W2 has a building screen W1 display intention input unit for switching to the building screen W1. In the sequential execution screen W2, when a sequential execution intention input unit is specified with the program P0 identifier specified, the execution means 104 sequentially executes one or more steps included in the macro that relates to the program P0 identifier. In the above, when the individual execution screen W3 display intention input unit is specified with the program P0 identifier specified, the input means 101 may specify one or more steps included in the macro that relates to the program P0 identifier.

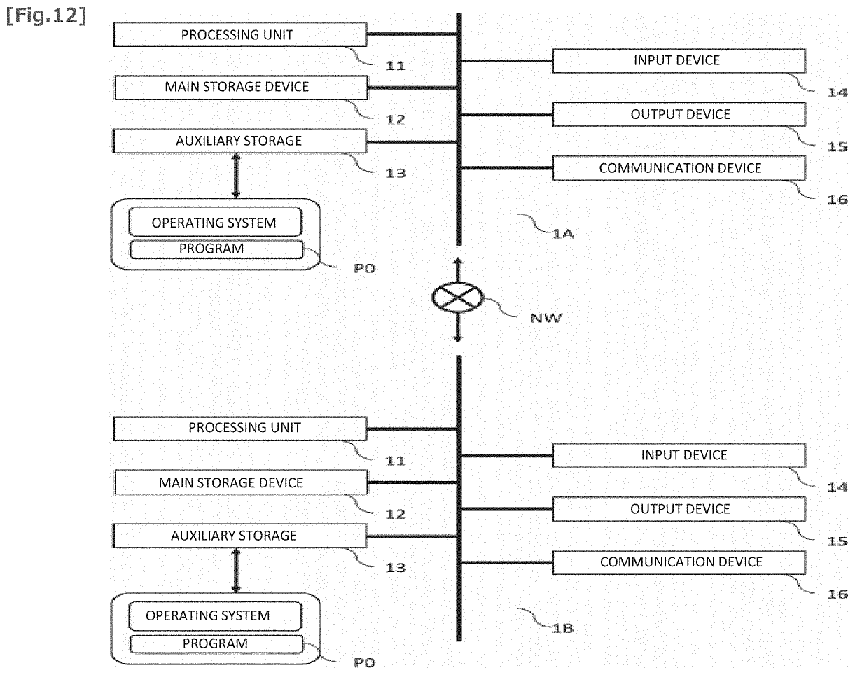

As shown in FIG. 12, the individual execution screen W3 includes a step specifying unit for specifying any of the steps included in the macro that relates to the program P0 identifier specified in the sequential execution screen W2. The individual execution screen W3 has an individual execution intention input unit for inputting the intention of the individual execution. When the individual execution intention input is specified with the step specified, the execution means 104 executes an information processing procedure that corresponds to the step. In the above, the individual execution may be performed in a state, where two or more steps, which are included in the macro, are specified.

The output means 102 may use a perceptual user interface in order to perform the display processing of the building screen W1, the sequential execution screen W2 and the individual execution screen W3. The input means 101 may use a perceptual user interface in order to perform the specifying processing. Specifically, the computer device 1 having an image sensor associates, with the specifying processing, a user's operation via a hand gesture. Further, the output means 102 may perform the display processing in a three-dimensional space using a head mount display, which mutually communicates with the computer device 1, and a pseudo hologram, which is drawn by the computer device 1.

Functions related to the system in the present embodiment include processing of transmitting and receiving of e-mails/messages. The transmitting and receiving is realized by the application programming interface. The above processing includes notifying information related to the results of the sequential execution or the individual execution. The above processing includes the input processing used for the setting of one or more information processing procedures by the building means 103. The present invention is not limited to the above, and at least a part of the functions related to the system may be realized by the transmitting and receiving of e-mails/messages. The above functions also include inputting to and outputting from a web browser screen by the application programming interface.

### Second Embodiment

Hereinafter, the second embodiment of the system according to the present invention will be described. Components similar to those of the first embodiment are designated by the same reference numerals and the description thereof will be omitted.

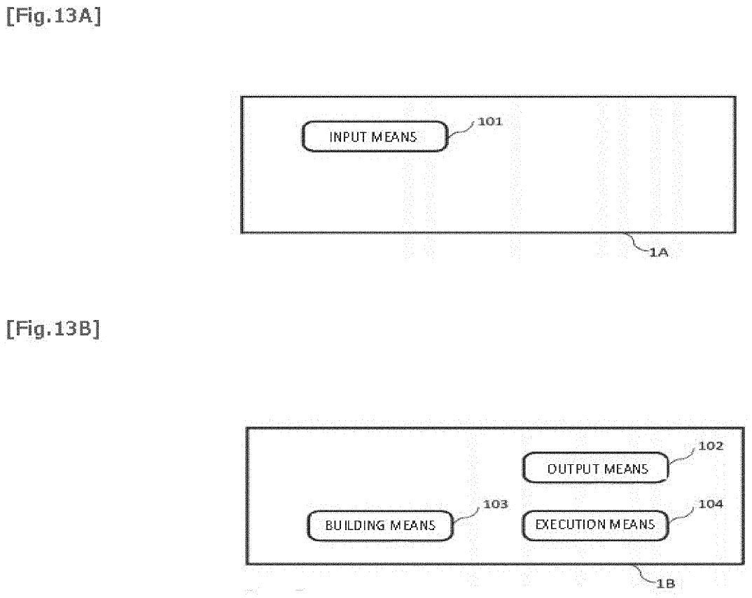

As shown in FIGS. 12, 13A and 13B, the system according to the second embodiment includes two different computer devices 1. A node 1A, which is one of the two different computer devices 1, has the input means 101. Further, a server 1B, which is the other one of the two different computer devices 1, includes the output means 102, the building means 103, and the execution means 104. In the above, the server 1B transmits a macro to the server 1B. The above macro is registered by the building means 103 and includes one or more information processing procedures and an execution order related to the one or more information processing procedures. In the above, the input means 101 performs the input processing using the input device 14 and the network NW including API. The display processing by the output means 102 is realized with the cooperation between the node 1A and the server 1B. Functions related to the system in the second embodiment are realized in a form of cloud computing There is no limitation to the numbers of the nodes 1A and the servers 1B in the system. The server 1B may not have the input device 14 and the output device 15.

According to the present invention, it is possible to provide a simpler automation method that improves the user experience in the software operation.

### Third Embodiment

Hereinafter, the third embodiment of the system according to the present invention will be described. Configurations similar to those of the first and second embodiments are designated by the same reference numerals and the description thereof will be omitted.

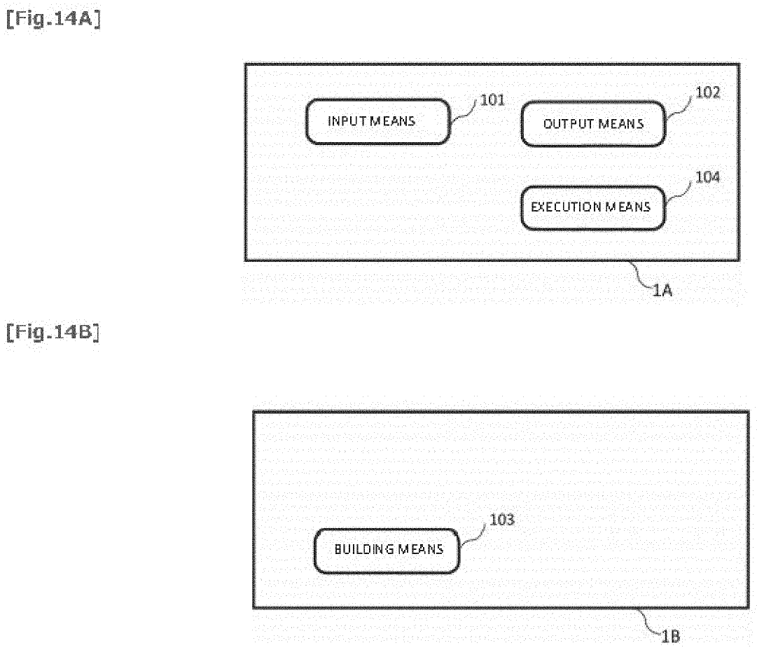

As shown in FIGS. 14A and 14B, the system according to the third embodiment includes two different computer devices 1. A node 1A, which is one of the two different computer devices 1, has the input means 101, the output means 102 and the execution means 104. Further, a server 1B, which is the other one of the two different computer devices 1, includes the building means 103. In the above, the server 1B transmits a macro to the node 1A. The above macro is registered by the building means 103 and includes one or more information processing procedures and an execution order related to the one or more information processing procedures. In the above, the server 1B may be alternatively configured to communicate a macro to the node 1A. The above macro is registered by the building means 103 and includes one or more information processing procedures and an execution order related to the one or more information processing procedures. Furthermore, In the above, the system may be configured such that the macro is first manipulated by the user, such as manually pasted, and then is communicated to the node 1A. The above macro is registered by the building means 103 and includes one or more information processing procedures and the execution order related to the one or more information processing procedures. In the above, the node 1A transmits, to the node 1A, the execution result of the one or more information processing procedures by the execution means 104. The input means 101 performs the input processing using the input device 14 and the network NW including API. The display processing by the output means 102 is realized with the cooperation between the node 1A and the server 1B. Some of the operations, effects, and functions in the third embodiment may be realized in a form of cloud computing. There is no limitation to the numbers of the nodes 1A and the servers 1B.

### Fourth Embodiment

Hereinafter, the fourth embodiment of the system according to the present invention will be described. Configurations similar to those of the first to third embodiments are designated by the same reference numerals and the description thereof will be omitted.

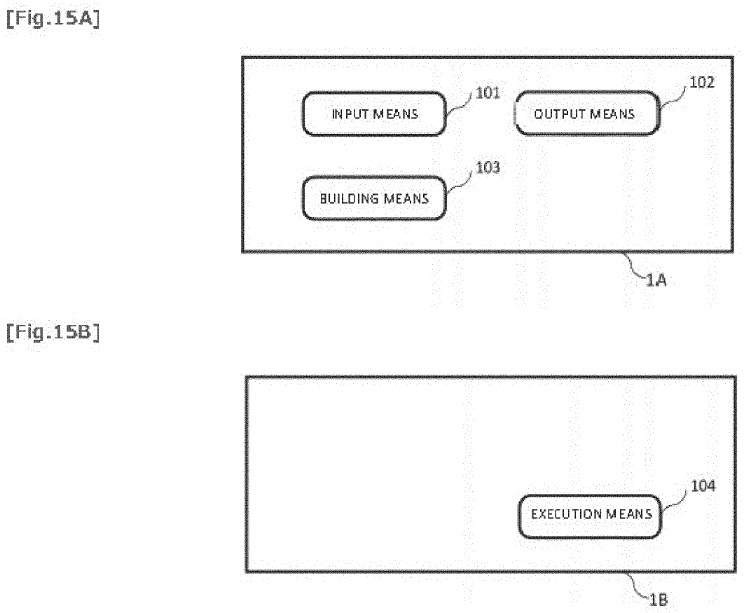

As shown in FIGS. 15A and 15B, the system according to the fourth embodiment includes two different computer devices 1. A node 1A, which is one of the two different computer devices 1, has the input means 101, the output means 102 and the building means 103. Further, a server 1B, which is the other one of the two different computer devices 1, includes the execution means 104. In the above, the node 1A transmits a macro to the server 1B. The above macro is registered by the building means 103 and includes one or more information processing procedures and an execution order related to the one or more information processing procedures. In the above, the server 1B transmits, to the node 1A, the execution result of the one or more information processing procedures by the execution means 104. The input means 101 performs the input processing using the input device 14 and the network NW including API. The display processing by the output means 102 is realized with the cooperation between the node 1A and the server 1B. Some of the operations, effects, and functions in the fourth embodiment may be realized in a form of cloud computing. There is no limitation to the numbers of the nodes 1A and the servers 1B.

### Fifth Embodiment

Hereinafter, the fifth embodiment of the system according to the present invention will be described. Configurations similar to those of the first to fourth embodiments are designated by the same reference numerals and the description thereof will be omitted.

As shown in FIGS. 16A and 16B, the system according to the fifth embodiment includes two different computer devices 1. A node 1A, which is one of the two different computer devices 1, has the input means 101 and the output means 102. Further, a server 1B, which is the other one of the two different computer devices 1, includes the building means 103 and the execution means 104. In the above, the server 1B transmits a macro to the server 1B. The above macro is registered by the building means 103 and includes one or more information processing procedures and an execution order related to the one or more information processing procedures. In the above, the server 1B transmits, to the node 1A, the execution result of the one or more information processing procedures by the execution means 104. The input means 101 performs the input processing using the input device 14 and the network NW including API. The display processing by the output means 102 is realized with the cooperation between the node 1A and the server 1B. Some of the operations, effects, and functions in the fifth embodiment may be realized in a form of cloud computing. There is no limitation to the numbers of the nodes 1A and the servers 1B.

### Sixth Embodiment

Hereinafter, the sixth embodiment of the system according to the present invention will be described. Configurations similar to those of the first to fifth embodiments are designated by the same reference numerals and the description thereof will be omitted.

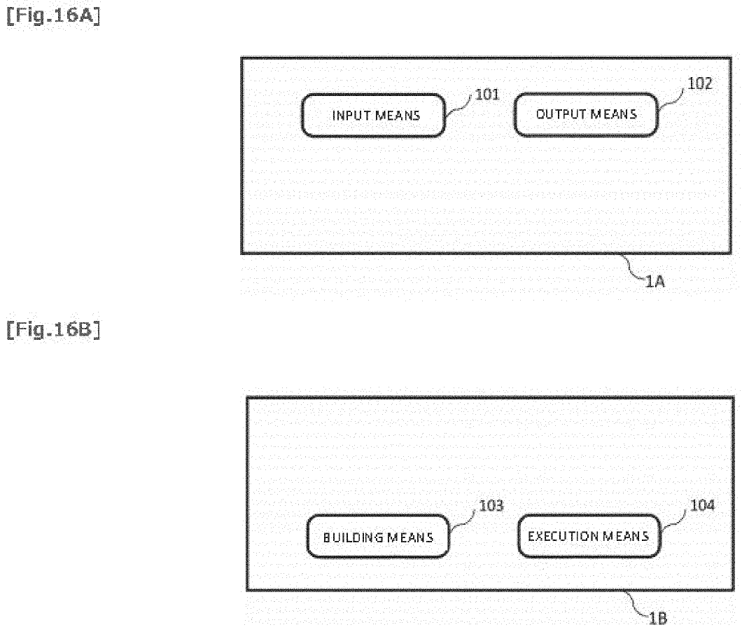

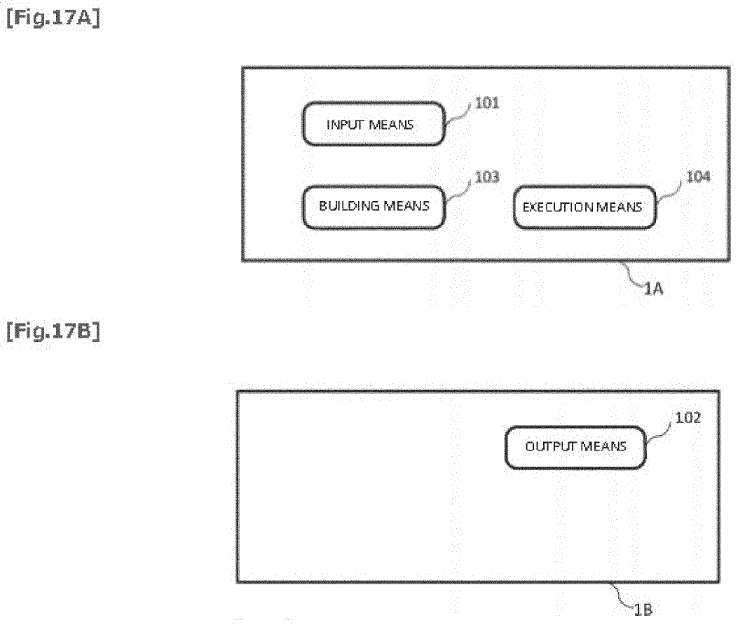

As shown in FIGS. 17A and 17B, the system according to the sixth embodiment includes two different computer devices 1. A node 1A, which is one of the two different computer devices 1, has the input means 101, the building means 103 and the execution means 104. Further, a server 1B, which is the other one of the two different computer devices 1, includes the output means 102. In the above, the node 1A transmits a macro to the node 1A. The above macro is registered by the building means 103 and includes one or more information processing procedures and an execution order related to the one or more information processing procedures. In the above, the node 1A transmits, to the server 1B, the execution result of the one or more information processing procedures by the execution means 104. The input means 101 performs the input processing using the input device 14 and the network NW including API. The display processing by the output means 102 is realized with the cooperation between the node 1A and the server 1B. Some of the operations, effects, and functions in the sixth embodiment may be realized in a form of cloud computing. There is no limitation to the numbers of the nodes 1A and the servers 1B.

### Seventh Embodiment

Hereinafter, the seventh embodiment of the system according to the present invention will be described. Configurations similar to those of the first to sixth embodiments are designated by the same reference numerals and the description thereof will be omitted.

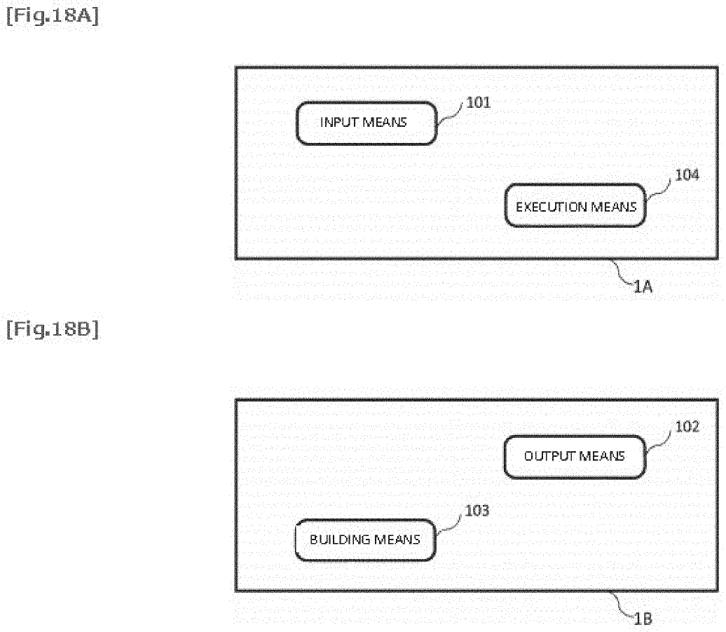

As shown in FIGS. 18A and 18B, the system according to the seventh embodiment includes two different computer devices 1. A node 1A, which is one of the two different computer devices 1, has the input means 101 and the execution means 104. Further, a server 1B, which is the other one of the two different computer devices 1, includes the output means 102 and the building means 103. In the above, the server 1B transmits a macro to the node 1A. The above macro is registered by the building means 103 and includes one or more information processing procedures and an execution order related to the one or more information processing procedures. In the above, the node 1A transmits, to the server 1B, the execution result of the one or more information processing procedures by the execution means 104. The input means 101 performs the input processing using the input device 14 and the network NW including API. The display processing by the output means 102 is realized with the cooperation between the node 1A and the server 1B. Some of the operations, effects, and functions in the seventh embodiment may be realized in a form of cloud computing. There is no limitation to the numbers of the nodes 1A and the servers 1B.

### Eighth Embodiment

Hereinafter, the eighth embodiment of the system according to the present invention will be described. Components similar to those of the first to seventh embodiments are designated by the same reference numerals and the description thereof will be omitted.

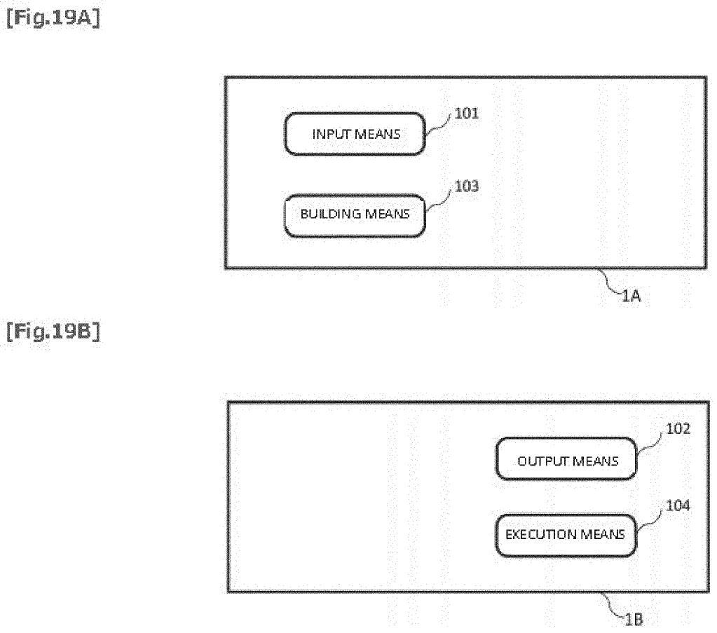

As shown in FIGS. 19A and 19B, the system according to the eighth embodiment includes two different computer devices 1. A node 1A, which is one of the two different computer devices 1, has the input means 101 and the building means 103. Further, a server 1B, which is the other one of the two different computer devices 1, includes the output means 102 and the execution means 104. In the above, the node 1A transmits a macro to the server 1B. The above macro is registered by the building means 103 and includes one or more information processing procedures and an execution order related to the one or more information processing procedures. In the above, the server 1B transmits, to the server 1B, the execution result of the one or more information processing procedures by the execution means 104. The input means 101 performs the input processing using the input device 14 and the network NW including API. The display processing by the output means 102 is realized with the cooperation between the node 1A and the server 1B. Some of the operations, effects, and functions in the eighth embodiment may be realized in a form of cloud computing. There is no limitation to the numbers of the nodes 1A and the servers 1B.

The output device 15 in one embodiment may be a conventional printer (printing device) or a data server, which is one example of a server device.

The above-mentioned “condition for branch processing” in one embodiment may include multiple conditions. Further, the above-mentioned “iterative processing range” may include multiple ranges. That is, the “condition for branch processing” and the “iterative processing range” may also have an n-to-n (n indicates a natural number) relationship in addition to a one-to-one relationship.

There are no restrictions on dimensions, object layouts, and colorations of various screens including the building screen W1, the sequential execution screen W2, and the individual execution screen W3 according to one embodiment.

In the processing flowcharts according to one embodiment, which includes the above-mentioned multiple steps, the flowcharts may be performed in any order unless otherwise specified.

In the description in the present specification, a “macro belonging to a spreadsheet” refers to a macro, which is a known macro (e.g., an Add-in and a personal macro), or which is a macro usable from an ordinary spreadsheet and contained in a separate file or an external file. In addition, the macro according to one embodiment of the present invention may be understood as a macro, which is contained in an external file or a separate file, and which is belonging, related, linked, or unique to a spreadsheet.

Note that the two different computer devices 1 according to one embodiment of the present invention are called a “node 1A” and a “server 1B”, respectively, for example. Alternatively, each of the two different computer devices 1 has no limitation on its type, such as a node, a client, a server, etc., and may have various configurations. Each of the two different computer devices may be a node (terminal) or alternatively a server.

### DESCRIPTION OF THE REFERENCE NUMERALS

P0 PROGRAM
1 COMPUTER DEVICE
11 PROCESSING UNIT
12 MAIN STORAGE DEVICE
13 AUXILIARY STORAGE DEVICE
14 INPUT DEVICE
15 OUTPUT DEVICE
16 COMMUNICATION DEVICE
101 INPUT MEANS
102 OUTPUT MEANS
103 BUILDING MEANS
104 EXECUTION MEANS
W1 BUILDING SCREEN
W1A OBJECT SPECIFYING UNIT
W1B CONDITION SPECIFYING UNIT
W1C PROCESS SPECIFYING UNIT
W2 SEQUENTIAL EXECUTION SCREEN
W3 INDIVIDUAL EXECUTION SCREEN
1A NODE
1B SERVER
NW NETWORK

1. An automation method causing a computer processor to execute a building step for registering a macro, which includes one or more information processing procedures and an execution order related to the one or more information processing procedures.

2. The automation method according to claim 1, further causing the computer processor to execute an execution step for performing a sequential execution for sequentially executing the one or more information processing procedures based on the execution order in response to specifying the macro, and an individual execution for individually executing at least one of the one or more information processing procedures in response to specifying the at least one of the one or more information processing procedures.

3. The automation method according to claim 1, wherein the building step is based on a graphical user interface.

4. The automation method according to claim 1, wherein the building step associates the one or more information processing procedures with branch processing and/or iterative processing.

5. The automation method according to claim 1, wherein the information processing procedure is a spreadsheet processing procedure.

6. The automation method according to claim 1, wherein the macro belongs to a spreadsheet.

7. The automation method according to claim 1, wherein the building step stores the macro on a main storage device, which serves as a volatile cache area.

8. The automation method according to claim 1, wherein the building step stores the macro on an auxiliary storage device, which serves as a non-volatile data area.

9. The automation method according to claim 2, wherein the execution step stores the macro on a main storage device, which serves as a volatile cache area.

10. The automation method according to claim 2, wherein the execution step stores the macro on an auxiliary storage device, which serves as a non-volatile data area.

11. An automation system comprising building means for registering a macro, which includes one or more information processing procedures and an execution order related to the one or more information processing procedures.

12. An automation program causing a computer to function as building means for registering a macro, which includes one or more information processing procedures and an execution order related to the one or more information processing procedures.
